(19) United States
(12) Patent Application Publication
(10) Pub. No.: US 2002/0010680 A1
(43) Pub. Date: Jan. 24, 2002

(54) Method for protection of electronic files from legal process and judgments

(76) Inventor: Scott Hillstrom, Eagan, MN (US)

Correspondence Address: WEISS & WEISS, SUITE 305, 500 OLD COUNTRY ROAD, GARDEN CITY, NY, 11530, US

(21) Appl. No.: 09/909,514

(22) Filed: Jul. 20, 2001

Related U.S. Application Data
(60) Provisional application No. 60/219,849, filed on Jul. 21, 2000.

(51) Int. Cl. G06F 17/60

(52) U.S. Cl. 705/51

(57) ABSTRACT

The present invention relates to a system and method for protecting electronic files from being forcibly accessed by legal process.

### FIELD OF THE INVENTION

The present invention relates to a system and method for protecting electronic files from being forcibly accessed by legal process.

### BACKGROUND OF THE INVENTION

Recently, there has been a dramatic increase in the creation, transmission and storage of confidential documents and messages in electronic formats (i.e., files). Many methods are in use restricting access to documents and messages in transit and storage by the use of encryption, passwords and the like. But even where access to documents and messages are protected from unauthorized access by these technologies, they may be forcibly accessed by legal process (e.g., subpoena). Once these files are accessed, the information found in these files may be used against persons who might have been able to protect these documents if they were not stored in electronic form in that jurisdiction.

Only governments can issue legal process, judgments and the like (collectively “Process”) and each government's power to enforce its Process is limited to the geographical territory over which its power extends. Enforcement power extends to a government's own territory and to the territory of other governments who have agreed to enforce that government's foreign Process. Not all governments have agreed to enforce the Process of some other governments. The present invention enables electronic files to be physically kept and controlled in a jurisdiction that does not recognize the Process of another jurisdiction whose Process the party in control of the file (the “Party”) does not wish to be enforced to access the file.

### SUMMARY OF THE INVENTION

The present invention combines the ubiquity of technology with laws limiting jurisdiction to provide further security to electronic files by physically placing the electronic files beyond the reach of the legal process.

The present invention relates to a method for protecting electronic files from being forcibly accessed by legal process comprising; creating and storing electronic files containing information. The present invention allows access by one or more memory storage devices located in jurisdictions that do not enforce the process of one or more other jurisdictions whose process a party wishes to protect the information and files from.

It is an object of the present invention to place the information under exclusive physical and legal control of a trustee or equivalent who is duly appointed under laws of a jurisdiction where the device or equivalent is located.

It is an object of the present invention to transfer the files to another device and trustee in another jurisdiction upon the happening of certain events. It is an object of the present invention to erase permanently the files from the memory device from which they are transferred. It is an object of the present invention to terminate a party's ability to access the files on the device upon the happening of an event and to continue or granting access to an alternate person who has been named in an agreement with the trustee.

It is an object of the present invention that the event is a subpoena demanding production of the information contained in the files stored on the device.

The present invention relates to a system for protecting electronic files from being forcibly accessed by legal process comprising; a device for creating and storing electronic files of information. The device allows access by one or more memory storage devices located in jurisdictions that do not enforce the process of one or more other jurisdictions whose process a party wishes to protect the information and files from. It is an object of the present invention for the device to place the information under exclusive physical and legal control of a trustee or equivalent who is duly appointed under laws of the jurisdiction where the device or an equivalent is located. It is an object of the present invention for the device to transfers the files to another device and trustee in another jurisdiction upon happening of certain events. It is an object of the present invention for the device to permanently erase the files from the memory device from which they are transferred. It is an object of the present invention for the device to terminate the party's ability to access the files on the device upon the happening of an event and continuing or granting access to an alternate person who has been named in an agreement with the trustee. It is an object of the present invention for the event to be a subpoena demanding production of the information contained in the files stored on the device.

Electronic files (e.g., email, pictures and text documents) are created, stored and accessed only on one or more memory storage devices located in jurisdictions that do not enforce the Process of one or more other jurisdictions whose Process the Party wishes to protect the information and files from (the “Device”). The device is under the exclusive physical and legal control of a trustee or equivalent who is duly appointed under the laws of the jurisdiction where the Device or equivalent could be located (“Trustee”). The system and process of the present invention allows the user to:

keep information in the files confidential,

restricts access to the files,

assists in responding to Process demanding the production of the information or access to the files,

transfers the files to another Device and Trustee in another jurisdiction upon the happening of certain events, and

permanently erases the files from the memory device from which they are transferred.

### DETAILED DESCRIPTION OF THE INVENTION

In a preferred embodiment, the Party's ability to access the files on the Device is terminated and an alternate person who has been named in the agreement with the Trustee continues to have or is granted access so that the Party cannot be forced to access the files against their will while the alternate person who has been named in the agreement with the Trustee continues to have or is granted access so that the Party cannot be forced to access the files against their will while the alternate person continues to have access after the Party's access is terminated.

In a preferred embodiment, the present invention transfers files from the Device in which they are stored to another Trustee and Device in another jurisdiction in the event that an attempt is made to enforce Process including when the Party demands access to the information while acting under Process or other compulsion. The present invention then permanently erases the files from the Device so that they can no longer be physically accessible on the Device.

### Examples:

1. An executive in the U.S. logs onto a Device of the present invention and creates and sends sensitive e-mail messages to other executives having a common interest in a legal matter that might result in litigation. The message is stored on the same or another Device and cannot be transferred to another system that is not a Device. A subpoena is issued demanding production of the messages contained in the files stored on the Device(s). A demand for the production of the e-mail files is served on the Trustee who controls the Device and the Trustee does not respond. Enforcement of the subpoena is sought in the jurisdiction where the Device(s) is located but the courts of that jurisdiction decline to enforce the subpoena because U.S. subpoenas are not recognized in the jurisdiction. The file(s) are not accessed and the information remains safe.

2. The same facts as above but with the addition that, when the Trustee is informed that there will be an attempt to enforce the subpoena in the jurisdiction where the Device is located, the present invention causes the files to be electronically transferred to another Device and Trustee in another jurisdiction as provided by a Trust Agreement (An agreement between a Party and a Trustee). The attempt to enforce the subpoena in the other jurisdiction triggers another transfer ad infinitum. Each time information is transferred to another Device it is permanently erased from the device from which it was transferred.

3. The same facts as above but with the addition that the Party's access to the files is terminated when the Trustee is informed that a subpoena has been issued; when enforcement is sought, or on the happening of some other event as provided in the Trust Agreement.

4. The same facts as above but with the addition that an alternate person was named in the Trust Agreement and the Trustee and the alternate's access to the files commences with or continues after the termination. The alternate person may be subject only to a jurisdiction in which a Device is or could be located.

5. The same facts as above but the Party is directed by an enforceable court order to use his ability to access the files on the Device to retrieve and produce the files. The present invention terminates the Party's access to the files and only the alternate person has access. The identity of the alternate person may not be known by the Party and, under the terms of the Trust Agreement, the identity may not be disclosed to the Party if the Party requests it acting under compulsion (e.g. court order).

What is claimed is:

1. A method for protecting electronic files from being forcibly accessed by legal process comprising;
creating and storing electronic files containing information;
allowing access by one or more memory storage devices located in jurisdictions that do not enforce said process of one or more other jurisdictions whose process a party wishes to protect said information and files from;
placing said information under exclusive physical and legal control of a trustee or equivalent who is duly appointed under laws of said jurisdiction where said device or equivalent is located.

2. The method of claim 1 further comprising;
transferring said files to another device and trustee in another jurisdiction upon happening of certain events.

3. The method of claim 1 further comprising;
erasing permanently said files from said memory device from which they are transferred.

4. The method of claim 2 further comprising;
terminating said party's ability to access said files on said device upon happening of said event and continuing or granting access to an alternate person who has been named in an agreement with said trustee.

5. The method of claim 2 wherein said event is a subpoena demanding production of said information contained in said files stored on said device.

6. A system for protecting electronic files from being forcibly accessed by legal process comprising;
a device for creating and storing electronic files of information;
said device allowing access by one or more memory storage devices located in jurisdictions that do not enforce said process of one or more other jurisdictions whose process a party wishes to protect said information and files from;
said device placing said information under exclusive physical and legal control of a trustee or equivalent who is duly appointed under laws of said jurisdiction where said device or an equivalent is located.

7. The system of claim 6 wherein said device transfers said files to another device and trustee in another jurisdiction upon happening of certain events.

8. The system of claim 6 wherein said device permanently erases said files from said memory device from which they are transferred.

9. The system of claim 7 wherein said device terminates said party's ability to access said files on said device upon happening of said events and continues or grants access to an alternate person who has been named in an agreement with said trustee.

10. The system of claim 7 wherein said event is a subpoena demanding production of said information contained in said files stored on said device.
